(19) United States
(12) Patent Application Publication
(10) Pub. No.: US 2015/0275827 A1
(43) Pub. Date: Oct. 1, 2015

(54) GAS REFORMATION WITH MOTOR DRIVEN COMPRESSOR

(71) Applicant: CATERPILLAR ENERGY SOLUTIONS GmbH, Mannheim (DE)

(72) Inventor: Michele Schilirò, Gomadingen (DE)

(73) Assignee: Caterpillar Energy Solution GmbH, Mannheim (DE)

(21) Appl. No.: 14/432,743

(22) PCT Filed: Oct. 2, 2012
(86) PCT No.: PCT/EP2012/069444

§ 371 Date: Mar. 31, 2015

(51) Int. Cl. F02M 25/12; F02B 33/44; F02B 39/10; F01N 5/02

(52) U.S. Cl. CPC F02M 25/12; F01N 5/02; F02B 33/44; F02B 39/10

(57) ABSTRACT

A spark-ignited gas engine includes a combustion chamber, a compressor, an exhaust gas duct, and a thermal reformer. The compressor is driven electrically by a motor and configured to load the combustion chamber with an air-gas-mixture. The thermal reformer is connected to at least a part of the exhaust gas duct to receive heat from the exhaust gas duct. The thermal reformer is configured to convert higher HCs to hydrogen (H₂). The higher HCs includes n carbon atoms and m hydrogen atoms according to at least one of the following reactions:

—CₙHₘ+nH₂O<<->>(m/2+n)H₂+nCO,

—CₙHₘ+(n/2)O₂<<->>(m/2)H₂+nCO,

and

—CₙHₘ+nCO₂<<->>(m/2)H₂+2nCO.

The present invention relates to a spark-ignited gas engine and a procedure for running a spark-ignited gas engine having an exhaust gas duct and at least one compressor for loading a combustion chamber with an air-gas-mixture and having a thermal reformer, said reformer converting higher HCs to hydrogen H₂ and carbon monoxide CO, said HCs consisting of n carbon atoms and m hydrogen atoms according to at least one of the following reactions into reform gas:

—CₙHₘ+ₙH2O <<->>_{(m/2+n)}H2+ₙCO,

—CₙHₘ+_{(n/2)}O2<<->>_{(m/2)}H2+ₙCO,

—CₙHₘ+ₙCO2<<->>_{(m/2)}H2+₂ₙCO.

This method uses a thermal reformation (TR), which is the combination of a catalytic oxidation step (catalytic partial oxidation—CPO) and a catalytic reaction to reform the gas using steam or carbon dioxide; thus, breaking the higher HCs, such as C3H8 (propane) or C4H10 (butane) into a mixture of CO, CH₄ and H2, called reform gas hereinafter.

The reactions this method takes advantage of include:

—CH4+H2O<<->>3H2+CO (3-1),

reforming of hydrocarbons (methane) with a specific energy of +205 KJ/mol

—CH4+½O2<<->>2H2+CO (3-2),

partial oxidation of hydrocarbons (methane) with a specific energy of −35.6 KJ/mol

—CH4+CO2<<->>2H2+2CO (3-3),

carbon dioxide reforming of hydrocarbons (methane) with a specific energy of +247.4 KJ/mol.

Reactions (3-1) or (3-3), which are endothermic, are coupled with reaction (3-2), which is exothermic. Because the temperature for the auto thermal reformation of higher HCs is less than that for methane, the use of the above referenced reactions will break the higher HCs into a mixture of CH4, CO and H2, by additionally using the thermal energy of the exhaust gas.

The reformer allows generating a steady gas quality, even when the quality of the natural gas available is unsteady. Additionally, the methane number can be kept stable in a smaller range, allowing a good combustion. Furthermore, the higher portion of hydrogen leads to low emissions of formaldehyde, i. e. methanal and nitrogen oxide, because hydrogen has a catalytic effect. While bio gas is being used, reaction (3-3) is used for reforming, i. e reducing the carbon dioxide, which is known as heat-trapping gas.

While using only the energy of the endothermic partial oxidation of hydrocarbons (methane) without the additional use of the thermal energy of the exhaust gas, this process is called auto thermal reformation (ATR).

DE 2 056 131 A discloses a procedure for running an Otto engine using petrol or fuel and adding hydrogen. The hydrogen is produced by catalytic reforming of hydrocarbons. In doing so, the energy for generating hydrogen is taken from the exhaust gas.

U.S. Pat. No. 7,210,467 B2 discloses an apparatus including a reciprocating internal combustion engine and a thermo chemical recuperator, in which a fuel is reformed. The thermo chemical recuperator is heated by exhaust gases from the reciprocating internal combustion engine and steam for the reforming process is produced by passing feed water through an engine lubricating oil heat exchanger, an engine cooling system heat recovery system and an exhaust gas heat recovery system arranged in series. It describes several reforming technologies to produce H2 as known. For example auto thermal reforming, partial oxidation reforming, plasma reforming, and steam reforming. Reforming of natural gas or other hydrocarbons produces H2-enriched products which, in addition to H2, may also include CO, CO2, and carbon.

The object of the invention is to configure and arrange a spark-ignited gas engine in such a manner that a higher degree of efficiency is realized.

According to the invention, the aforesaid object is achieved, in that the reformer is connected to at least a part of the exhaust gas duct for supplying the reformer with heat and at least one compressor is motor-driven, respectively at least one compressor is not driven via an exhaust gas turbine.

According to the invention, the aforesaid object is also achieved by said procedure in which the reformer is supplied with heat from at least a part of the exhaust gas stream and in which at least one compressor is being motor-driven.

In order to achieve a higher efficiency, the compressor (of the turbocharger) for loading a combustion chamber with an air-gas-mixture should be driven by an electric motor instead of exhaust gas; i. e. the gas is loaded via an electrical compressor without the use of the exhaust gas turbine. This allows the exhaust gas to keep 100° C. to 150° C. more of its thermal energy, i.e. a higher temperature of about 550° C. to 600° C., which can be used for the endothermic processes (3-1) and (3-3).

The efficiency factor of an engine-generator unit with a power of 150 kW, and without thermal reformation is about 40%. Adding the thermal reformation, the efficiency factor can be increased up to 43%. Additionally, by using an electrically driven compressor, the efficiency factor can be further increased up to 43.3%.

Although energy is required to drive the electric motor, the overall engine efficiency is higher. One reason is the fact that the efficiency of the reforming process is much higher than the efficiency of the turbine.

It can also be advantageous having a reformer that converts only higher HCs (CₙHₘ), which have at least two or three carbon atoms, i. e. n>=2 or n>=3, i. e. converting only higher HCs, which have at least two or three carbon atoms. Therefore, methane, for which a higher temperature would be necessary, is not reformed. Beside this, it is advantageous if the methane is directly burned in the combustion chamber without reforming it to hydrogen.

Another increase in efficiency is achieved with an exhaust gas turbine and with at least one further generator, said further generator being driven mechanically via the exhaust gas turbine, said turbine being positioned downstream to the reformer. Adapted to the procedure, the engine has an exhaust gas turbine and at least one further generator, said further generator being driven mechanically via the exhaust gas turbine, said turbine being positioned downstream to the reformer. The remaining pressure of the exhaust gas downstream to the reformer is used for generating power, which can be used for the electrically driven compressor.

Especially stationary engines which are integrated in a cogeneration KWK process are supplied with natural gas which reformation is advantageous, especially in view of generating a steady gas quality, i.e. better combustion.

Other advantages and details of the invention are explained in the claims and in the description and shown in the FIGURE, said FIGURE showing a schematic diagram of a supply chain of an engine generator unit with a reformer.

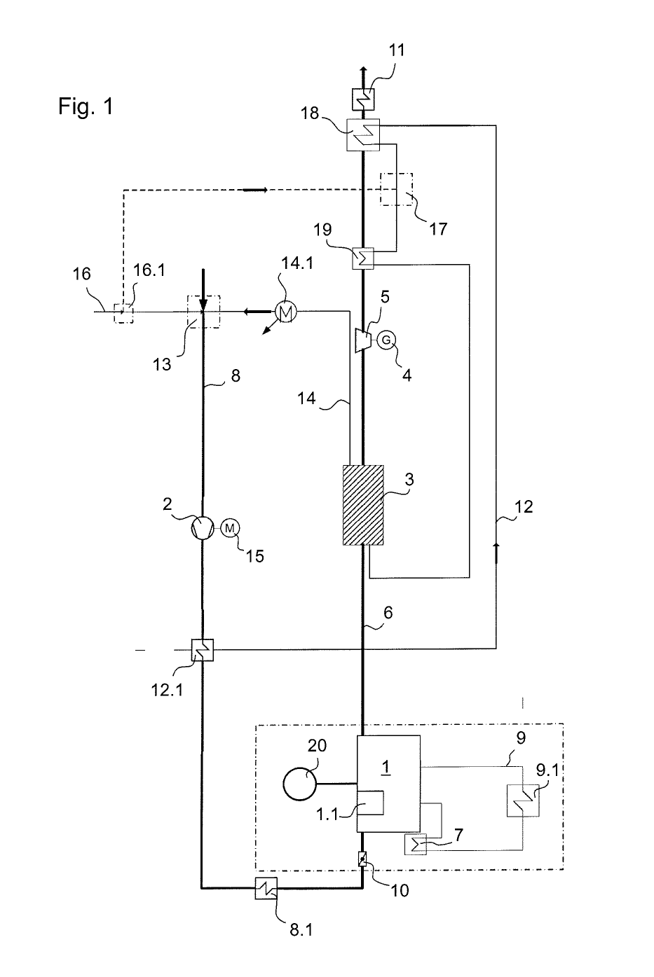

The schematic diagram in FIG. 1 shows the supply chain of a spark-ignited gas engine 1 with an air-gas mixture and the exhaust system of the spark-ignited gas engine 1.

Starting from a gas mixer 13 at which the ambient air is mixed with the combustion gas and a reform gas, an air-gas duct 8 is conducted via a compressor 2 and an air gas cooler 8.1 to the spark-ignited gas engine 1 or to a combustion chamber 1.1 of the spark-ignited gas engine 1. A throttle valve 10 that is controlled based on the output of the spark-ignited gas engine 1 is provided in this air-gas duct 8 immediately upstream of the spark-ignited gas engine 1.

The compressor 2 is driven by an electric motor 15. There is therefore no need for an exhaust gas turbine 5. The exhaust gas, when it enters a reformer 3 described below, has a temperature that is 100° C. to 150° C. higher. This higher temperature contributes to the enhanced operation of the reformer 3.

The spark-ignited gas engine 1 comprises an exhaust gas duct 6 in which the reformer 3 for gas is provided downstream from the spark-ignited gas engine 1. The heat of the exhaust gas is in part dissipated to the reformer 3 via a heat exchanger not shown here.

Downstream from the reformer 3, an exhaust gas turbine 5 is provided with a generator 4 coupled to it. Further expansion of the exhaust gas generates electricity that can also be used for the motor 15.

The exhaust gas turbine 5 is followed by a heat exchanger or superheater 19 and an evaporator 18 for the water circuit 12 described below. An exhaust gas heat exchanger 11 is provided downstream before the exhaust gas is carried off to the exhaust system not shown here.

A water circuit or water duct 12 is provided for supplying the reformer 3 with water vapor for producing reform gas. First, the water carried in it is preheated by a water heat exchanger 12.1 coupled to the air-gas duct 8, wherein the heat is taken from the compressed exhaust gas-air mixture. Then the water is heated in the evaporator 18 mentioned above, and the vapor is overheated accordingly in the downstream superheater 19 before it is returned to the reformer 3.

A gas-steam mixing point 17 for adding combustion gas to the water vapor is provided between the evaporator 18 and the superheater 19. The mixing point 17 is connected to the gas duct 16 via the valve 16.1 for gas.

The reform gas that is produced during reformation is fed to the air gas-reform gas mixer 13, and thus to the air-gas mixture, for combustion in the spark-ignited gas engine 1 via a reform gas duct 14 and a condenser 14.1.

In addition, the spark-ignited gas engine 1 comprises a cooling circuit 9 with an engine heat exchanger 9.1 for cooling the spark-ignited gas engine 1. The cooling circuit 9 is also connected to an oil heat exchanger 7.

The measure described above for the reformer 3 considerably improves the efficiency of a spark-ignited gas engine 1-generator 10 unit.

### REFERENCE LIST

1 spark-ignited gas engine
1.1 combustion chamber
2 compressor
3 reformer
4 further generator
5 exhaust gas turbine
6 exhaust gas duct
7 oil heat exchanger
8 air gas duct
8.1 air gas cooler
9 cooling system/circuit
9.1 engine heat exchanger
10 throttle valve
11 exhaust gas heat exchanger
12 water circuit, water duct
12.1 heat exchanger water
13 air gas—reform gas mixer
14 reform gas duct
14.1 condensor
15 motor
16 gas duct
16.1 valve for gas
17 mixing point gas/steam
18 evaporator
19 superheater
20 power generator

1. A spark-ignited gas engine, comprising:
a combustion chamber;
a compressor electrically driven by a motor, wherein the compressor is configured to load the combustion chamber with an air-gas-mixture;
an exhaust gas duct; and
a thermal reformer connected to at least a part of the exhaust gas duct to receive heat from the exhaust gas duct, wherein the thermal reformer is configured to convert higher HCs to hydrogen (H₂), and the HCs consist of n carbon atoms and m hydrogen atoms according to at least one of the following reactions:
—CₙHₘ+nH₂O<<->>(m/2+n)H₂+nCO,
—CₙHₘ+(n/2)O₂<<->>(m/2)H₂+nCO,
and
—CₙHₘ+nCO₂<<->>(m/2)H₂+2nCO.

2. The spark-ignited gas engine according to claim 1, wherein the higher HCs comprise at least two carbon atoms.

3. The spark-ignited gas engine according to claim 1, further comprising:
an exhaust gas turbine positioned downstream to the thermal reformer; and
a further generator mechanically driven via the exhaust gas turbine.

4. The spark-ignited gas engine according to claim 1, wherein the engine is a stationary engine.

5. A method of running a spark-ignited gas engine, wherein the spark-ignited engine comprises a compressor, a combustion chamber, an exhaust gas duct, and a thermal reformer, the method comprising:
driving the compressor electronically by a motor;
loading the combustion chamber with an air-gas-mixture by the compressor;
generating an exhaust gas stream by the spark-ignited gas engine;
supplying the thermal reformer with heat from at least a part of the exhaust gas stream;
converting higher HCs to hydrogen (H2) by the thermal reformer, wherein the HCs consist of n carbon atoms and m hydrogen atoms according to at least one of the following reactions:
—CₙHₘ+nH₂O<<->>(m/2+n)H₂+nCO,
—CₙHₘ+(n/2)O₂<<->>(m/2)H₂+nCO,
and
—CₙHₘ+nCO₂<<->>(m/2)H₂+2nCO.

6. The method according to claim 5, wherein the higher HCs comprise at least two carbon atoms.

7. The method according to claim 5, wherein the spark-ignited gas engine further comprises an exhaust gas turbine positioned downstream to the thermal reformer, and a further generator for generating power, the method further comprising:
driving the further generator mechanically via the exhaust gas turbine.

8. The spark-ignited gas engine according to claim 2, further comprising:
an exhaust gas turbine positioned downstream to the thermal reformer; and
a generator mechanically driven via the exhaust gas turbine.

9. The spark-ignited gas engine according to claim 2, wherein the engine is a stationary engine.

10. The spark-ignited gas engine according to claim 3, wherein the engine is a stationary engine.

11. The spark-ignited gas engine according to claim 8, wherein the engine is a stationary engine.

12. The method according to claim 6, wherein the spark-ignited gas engine further comprises an exhaust gas turbine positioned downstream to the thermal reformer, and a further generator for generating power, the method further comprising:
driving the further generator mechanically via the exhaust gas turbine.

13. A thermal reformer for reforming gas of a spark-ignited gas engine, wherein the spark-ignited gas engine comprises a combustion chamber, a compressor electrically driven by a motor and configured to load the combustion chamber with an air-gas-mixture, and an exhaust gas duct, the thermal reformer being:
connected to at least a part of the exhaust gas duct to receive heat from the exhaust gas duct; and
configured to convert higher HCs to hydrogen (H₂), wherein the HCs consist of n carbon atoms and m hydrogen atoms according to at least one of the following reactions:
—CₙHₘ+nH₂O<<->>(m/2+n)H₂+nCO,
—CₙHₘ+(n/2)O₂<<->>(m/2)H₂+nCO,
and
—CₙHₘ+nCO₂<<->>(m/2)H₂+2nCO.

14. The thermal reformer according to claim 13, wherein the higher HCs comprise at least two carbon atoms.

15. The thermal reformer according to claim 13, wherein the spark-ignited gas engine further comprises an exhaust gas turbine, and a further generator mechanically driven via the exhaust gas turbine, wherein the exhaust gas turbine is positioned downstream to the thermal reformer.

16. The thermal reformer according to claim 14, wherein the spark-ignited gas engine further comprises an exhaust gas turbine, and a further generator mechanically driven via the exhaust gas turbine, wherein the exhaust gas turbine is positioned downstream to the thermal reformer.

17. The thermal reformer according to claim 13, wherein the thermal reformer is used in a stationary engine.

18. The thermal reformer according to claim 14, wherein the thermal reformer is used in a stationary engine.

19. The thermal reformer according to claim 15, wherein the thermal reformer is used in a stationary engine.

20. The thermal reformer according to claim 16, wherein the thermal reformer is used in a stationary engine.
